(19) United States
(12) Patent Application Publication
(10) Pub. No.: US 2009/0060273 A1
(43) Pub. Date: Mar. 5, 2009

(54) SYSTEM FOR EVALUATING AN IMAGE

(75) Inventors: Martin Stephan, Ettlingen (DE); Stephan Bergmann, Muggensturm (DE)

Correspondence Address: THE ECLIPSE GROUP LLP, 10605 BALBOA BLVD., SUITE 300, GRANADA HILLS, CA, 91344, US

(73) Assignee: Harman Becker Automotive Systems GmbH, Karlsbad (DE)

(21) Appl. No.: 12/184,977

(22) Filed: Aug. 1, 2008

(30) Foreign Application Priority Data
Aug. 3, 2007 (EP) EP 07 015 282.2

(51) Int. Cl. G06K 9/62

(52) U.S. Cl. 382/103

(57) ABSTRACT

In a system for evaluating an image, a processing device includes an input for receiving image data representing the image and another input for receiving distance information on a distance of an object relative to an image plane of the image. The distance information may be determined based on a three-dimensional image including depth information captured utilizing a 3D camera device. The processing device is configured for resampling at least a portion of the image data based both on the distance information and on a pre-determined reference distance to generate resampled image data, the portion of the image data to be resampled representing at least part of the object.

### RELATED APPLICATIONS

This application claims priority of European Patent Application Serial Number 07 015 282.2, filed on Aug. 3, 2008, titled METHOD AND APPARATUS FOR EVALUATING AN IMAGE, which application is incorporated in its entirety by reference in this application.

### BACKGROUND OF THE INVENTION

1. Field of the Invention

This invention relates to a system for evaluating an image. In particular, this invention relates to a system for evaluating an image that may be employed for object recognition in various environments such as, for example, in a driver assistance system onboard a vehicle or in a surveillance system.

2. Related Art

Nowadays, vehicles provide a plurality of driver assistance functions to assist the driver in controlling the vehicle and/or to enhance driving safety. Examples of such driver assistance functions include parking aids, collision prediction functions and safety features including airbags or seat belt retractors that may be actuated according to control logics. Some of these driver assistance functions may rely on, or at least harness, information on surroundings of the vehicle in the form of image data that is automatically evaluated to, e.g., detect approaching obstacles. In some driver assistance functions, not only the presence of an object in proximity to the vehicle, but also its “type” or “class”, such as vehicle or pedestrian, may be automatically determined so that appropriate action may be taken based on the determined object class. This may be achieved by capturing an image having a field of view that corresponds to a portion of the vehicle surroundings and evaluating the image data representing the image to detect objects and to determine their respective object class, based on, e.g., characteristic geometrical features and sizes of objects represented by the image data, which may be compared to reference data. Such a conventional approach to image evaluation frequently has shortcomings associated with it. For example, when the image data is directly compared to reference data, the reliability of object classification may depend on the distance of the object relative to the vehicle in which the driver assistance function is installed. For example, a lorry at a large distance from the vehicle may be incorrectly identified as a car at a shorter distance from the vehicle, or vice versa, due to the larger lateral dimensions of the lorry.

Similar problems exist in other situations in which an automatic identification of objects in an image is desirable, such as surveillance camera systems installed in public areas or private property.

Therefore, a need exists in the art for an improved system for evaluating an image. In particular, there is a need for an improved system for evaluating an image, which provides results that are less prone to errors caused by a variation in distance of an object relative to a camera that captures the image to be evaluated.

### SUMMARY

According to one implementation, a method for evaluating an image is provided. Image data representing the image is retrieved. Distance information on a distance of an object relative to an image plane of the image is retrieved. At least part of the object is represented by the image data. At least a portion of the image data is resampled, based both on the distance information and on a pre-determined reference distance to generate resampled image data. The portion of the image data to be resampled represents at least part of the object.

According to another implementation, an apparatus for evaluating an image is provided. The apparatus may include a processing device. The processing device may include a first input for receiving image data representing the image, and a second input for receiving distance information on a distance of an object relative to an image plane of the image. At least part of the object is represented by the image. The processing device is configured for resampling at least a portion of the image data based both on the distance information and on a pre-determined reference distance to generate resampled image data. The portion of the image data to be resampled represents at least part of the object.

According to another implementation, a driver assistance system is provided. The driver assistance system may include an image evaluating apparatus and an assistance device configured for receiving an image evaluation result from the image evaluating apparatus.

According to another implementation, a method for evaluating an image is provided. The image to be evaluated is captured. A three-dimensional image is also captured. The three-dimensional image includes depth information. A field of view of the three-dimensional image overlaps with a field of view of the image to be evaluated. At least a portion of the captured image is resampled based on the three-dimensional image.

According to another implementation, an apparatus for evaluating an image is provided. The apparatus may include a camera device for capturing an image, a three-dimensional camera device configured for capturing a three-dimensional image, and a processing device coupled to the camera device and to the three-dimensional camera device. The three-dimensional image captured by the three-dimensional camera includes depth information. A field of view of the three-dimensional image overlaps with a field of view of the image to be evaluated. The processing device is configured for receiving image data representing the image to be evaluated from the camera device, and for receiving additional image data from the three-dimensional camera device. The additional image data represent the three-dimensional image. The processing device is also configured for resampling at least a portion of the image data based on the additional image data.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a schematic diagram of an example of a driver assistance system that includes an apparatus for evaluating an image according to an implementation of the invention.

FIG. 2 is a flow diagram of an example of a method for evaluating an image according to an implementation of the invention.

FIG. 3 is a flow diagram of an example of a method for evaluating an image according to another implementation of the invention.

FIG. 4(a) is a schematic representation of an example of a 2D image.

FIG. 4(b) is a schematic representation illustrating a resampling of portions of the image of FIG. 4(a).

FIG. 5 is a schematic top plan view of objects on a road segment.

FIG. 6 is a schematic representation of a 2D image of the road segment of FIG. 5.

FIG. 7 is a schematic representation of a 3D image of the road segment of FIG. 5.

FIGS. 8(a), 8(b) and 8(c) are schematic representations of portions of the 2D image of FIG. 6 that may be subject to resampling.

FIG. 9 is a flow diagram of an example of a method for evaluating an image according to another implementation of the invention.

FIG. 10 is a schematic diagram of an example of a driver assistance system that includes an apparatus for evaluating an image according to another implementation of the invention.

FIG. 11 is a flow diagram of an example of a method for evaluating an image according to another implementation of the invention.

### DETAILED DESCRIPTION

Hereinafter, examples of implementations of the invention will be explained with reference to the drawings. It is to be understood that the following description is given only for the purpose of better explaining the invention and is not to be taken in a limiting sense. It is also to be understood that, unless specifically noted otherwise, the features of the various implementations described below may be combined with each other.

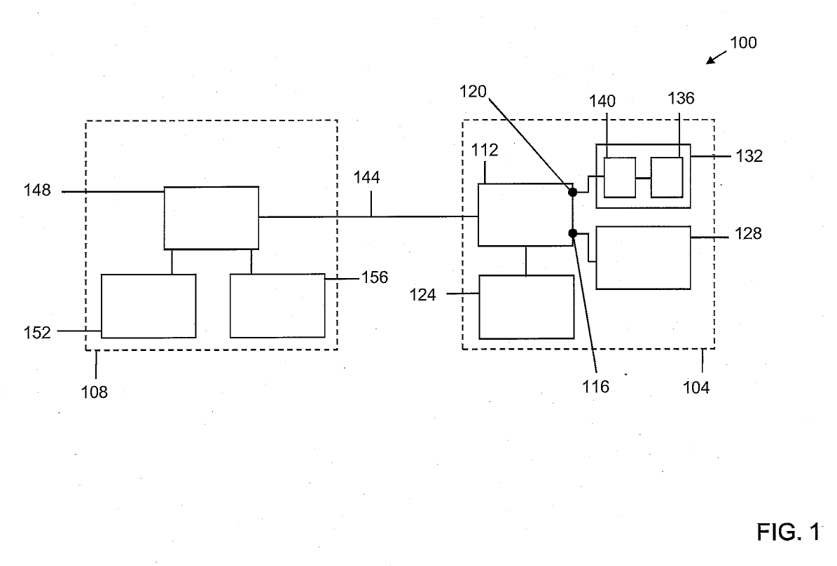

FIG. 1 is a schematic diagram of an example of a driver assistance system 100 according to one implementation. The driver assistance system 100 may include an apparatus 104 for evaluating an image and an assistance device 108. The image evaluating apparatus 104 may include a processing device 112. The processing device 112 may include a first input 116 for receiving image data representing the image to be evaluated and a second input 120 to receive distance information on a distance of an object relative to an image plane. In this context, the term “image plane” generally refers to the (usually virtual) plane onto which the image to be evaluated is mapped by the optical system that captures the image, as described further below. The processing device 112 may be coupled to a storage device 124 that may store reference data for object classification. In this context, the term “classification” of an object generally refers to a process in which it is determined whether the object belongs to one of a number of given object types or classes such as, for example, cars, lorries or trucks, motorcycles, traffic signs and/or pedestrians.

The first input 116 of the processing device 112 may be coupled to a two-dimensional (2D) camera 128 that captures the image to be evaluated and provides the image data representing the image to the processing device 112. The 2D camera 128 may be configured, e.g., as a CMOS or CCD camera and may include additional circuitry to process the image data prior to outputting the image data to the processing device 112. For example, the image data may be filtered or suitably encoded before being output to the processing device 112.

The second input 120 of the processing device 112 may be coupled to a three-dimensional (3D) camera device 132. The 3D camera device 132 may include a 3D camera 136 and an object identification device 140 coupled to the 3D camera 136. The 3D camera 136 captures additional (3D) image data. This additional image data represents a three-dimensional image including depth information for a plurality of viewing directions, i.e., information on a distance of a closest obstacle located along a line of sight in one of the plurality of viewing directions. The object identification device 140 receives the additional image data representing the three-dimensional image from the 3D camera 136 and determines the lateral positions of objects within the field of view of the 3D camera 136 and their respective distances based on the depth information. The object identification device 140 may be configured to perform a segmentation algorithm, in which adjacent pixels that have comparable distances from the 3D camera are assigned to belong to one object. Additional logical functions may be incorporated into the object identification device 140. For example, if only vehicles are to be identified in the image data, then only regions of pixels in the additional image data that have shapes similar to a rectangular or trapezoidal shape may be identified, so that objects that do not have a shape that is typically found for a vehicle are not taken into account when evaluating the image data. The object identification device 140 may identify the lateral positions of all objects of interest in the additional image data, i.e., the coordinates of regions in which the objects are located, and may determine a distance of the respective objects relative to the 3D camera 136. This data, also referred to as “object list” in the following, is then provided to the processing device 112.

The 2D camera 128 and the 3D camera 136 of the 3D camera device 132 may be arranged and configured such that a field of view of the 2D camera 128 overlaps with a field of view of the 3D camera 136. In one implementation, the fields of view essentially coincide. For simplicity, it will be assumed that the 2D camera 128 and the 3D camera 136 are arranged sufficiently close to one another that the depth information captured by the 3D camera 136 also provides a good approximation for the distance of the respective object from the image plane of the 2D camera 128. It will be appreciated that, in other implementations, the 2D camera 128 and the 3D camera 136 may also be arranged remotely from each other, in which case a distance of an object relative to the image plane of the 2D camera 128 may be derived from the depth information captured by the 3D camera 136, when the position of the 3D camera 136 relative to the 2D camera 128 is known.

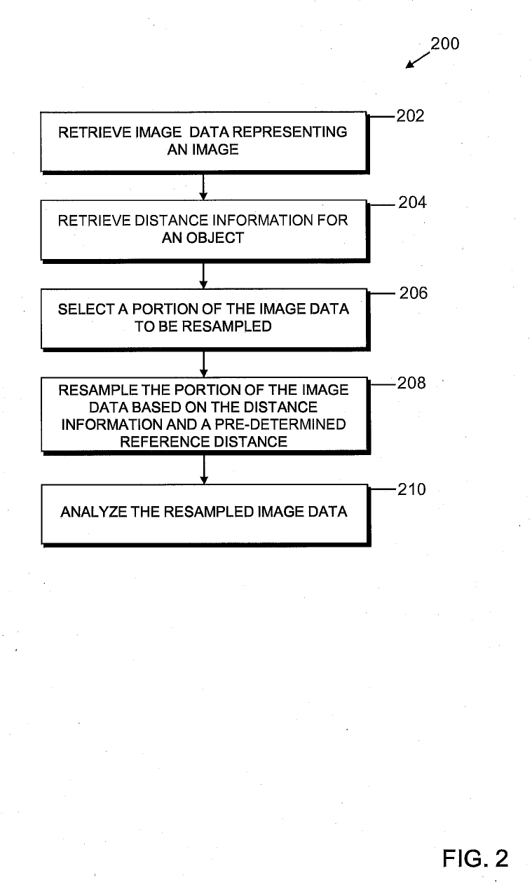

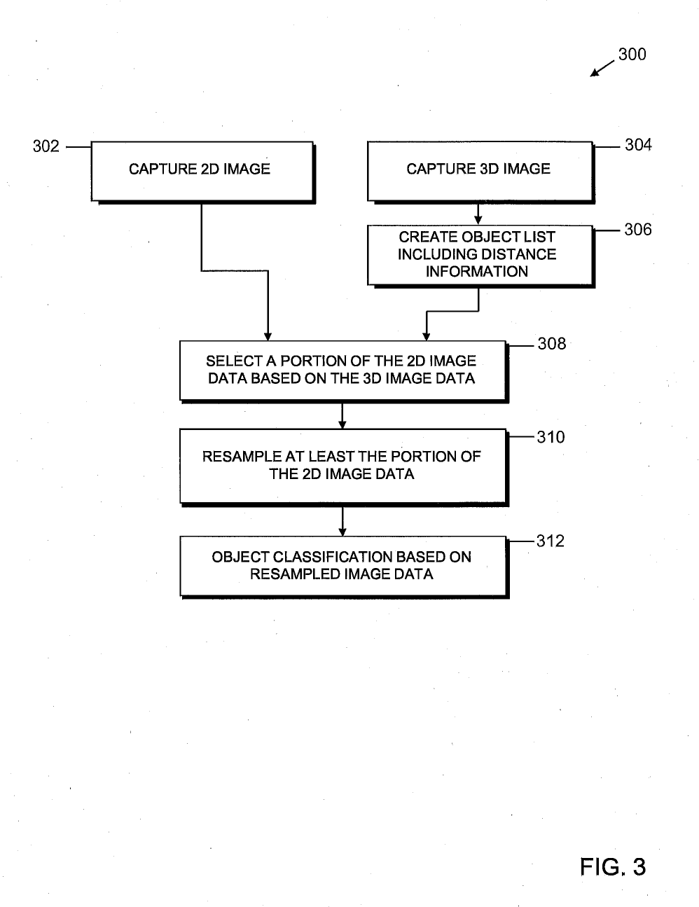

The processing device 112 receives the object list from the 3D camera device 132, which includes distance information for at least one object, and usually plural objects, that are represented in the image captured by the 2D camera 128. As will be explained in more detail with reference to FIGS. 2 and 3 below, the processing device 112 resamples at least a portion of the image data based on the distance information for an object represented by the image data and based on a pre-determined reference distance to generate resampled image data that are then evaluated further. By resampling a portion of the image data representing the object of interest based on both the distance of the object relative to the image plane and the pre-determined reference distance, in this apparatus 104 distance-related effects may at least partially be taken into account before analyzing the resampled image data, e.g., object classification.

The apparatus 104 may be coupled to the assistance device 108 via a bus 144 to provide a result of the image evaluation to the assistance device 108. The assistance device 108 may include a control device 148, and an output unit or warning device 152 and an occupant and/or pedestrian protection device 156 coupled to the control device 148. Based on the signal received from the apparatus 104 via the bus 144, the control device 148 actuates one or both of the warning device 152 and the protection device 156. The warning device 152 may be configured for providing at least one of optical, acoustical or tactile output signals based on a result of an image evaluation performed by the apparatus 104. The occupant and/or pedestrian protection device 156 may also be configured to be actuated based on a result of an image evaluation performed by the apparatus 104. For example, the protection system 156 may include a passenger airbag that is activated when a collision with a vehicle is predicted to occur based on the result of the image evaluation, and/or a pedestrian airbag that is activated when a collision with a pedestrian is predicted to occur.

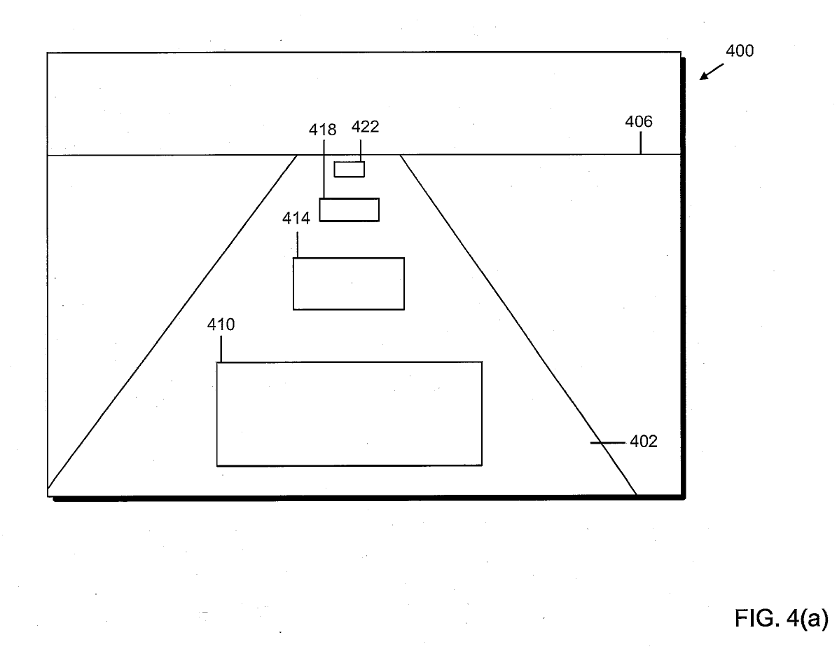

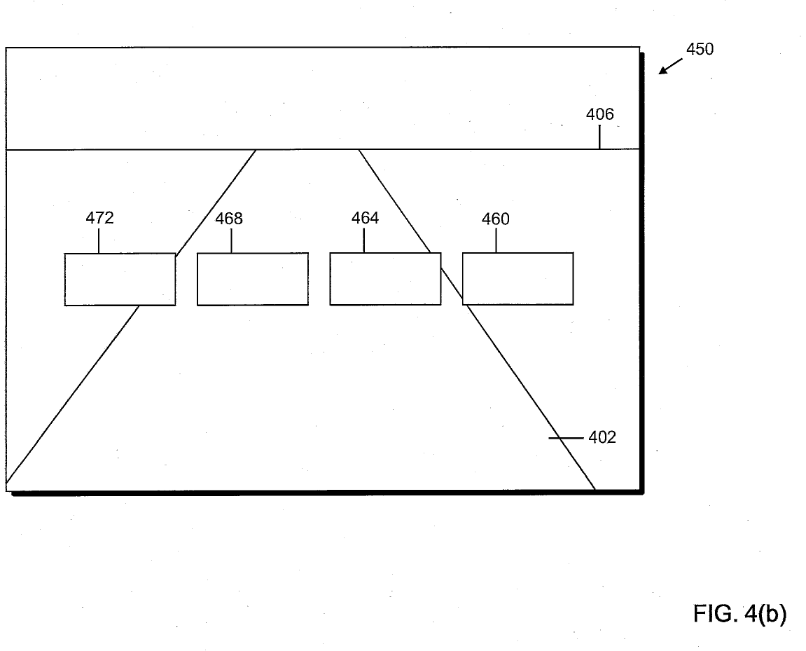

FIG. 2 is a flow diagram illustrating an example of a method 200 that may be performed by the processing device 112 of the apparatus 104. At step 202, image data representing an image are retrieved. The image data may be retrieved directly from a camera, e.g., the 2D camera 128, or from a storage medium. At step 204, distance information on a distance of the object from the image plane is retrieved. The distance information may be a single numerical value, but may also be provided in any other suitable form, e.g., in the form of an object list that includes information on lateral positions and distances for one or plural objects. At step 206, a portion of the image data that is to be resampled is selected. The portion of the image data to be resampled may be selected in various ways. If the distance information is obtained from additional image data representing a 3D image, step 206 may include identifying a portion of the image data that corresponds to a portion of the additional (3D) image data representing at least part of the object, to thereby match the image data and the additional image data. At step 208, the portion selected at step 206 is resampled based on both the distance information and a pre-determined reference distance. Therefore, a subsequent analysis of the resampled image data is less likely to be affected by the distance of the object relative to the image plane, because the method allows distance-related effects to be at least partially taken into account by resampling the portion of the image data. In one implementation, a resampling factor is selected based on both the distance information and the reference distance. By selecting the resampling factor based on a comparison of the distance of the object and the reference distance, the portion of the image data representing the object may be increased or decreased in size to at least partially accommodate size-variations of the object image as a function of object distance. As will be explained in more detail with reference to FIGS. 4(a) and 4(b) below, the resampling factor may be selected so that, in the resampled image data, a pixel corresponds to a width of the imaged object that is approximately equal to a width per pixel for an object imaged when it is located at the reference distance from the image plane. In this manner, the object image is resealed to have approximately the size that it would have when the object would have been imaged at the reference distance. Consequently, size variations of the object effected by distance-variations relative to the image plane may be at least partially taken into account. At step 210, the resampled image data may be analyzed further as described below.

For reasons of simplicity, the method 200 has been explained above with reference to a case in which only one object of interest is represented by the image data. When plural objects of interest are visible in the image, the steps 204-206 may be performed for each of the objects, or for a subset of the objects that may be selected in dependence on the object types of interest, for example by discarding objects that do not have a roughly rectangular or trapezoidal boundary. It will be appreciated that the distance information retrieved at step 204 may vary for different objects, and that the resampling performed at step 208 may correspondingly vary in accordance with the different distances relative to the image plane. When the image data represent several objects, steps 204-210 may be performed successively for all objects, or the step 204 may first be performed for each of the objects, and subsequently the step 206 is performed for each of the objects, etc.

The further analysis of the resampled image data at step 210 may, e.g., include comparing the resampled image data to reference data to classify the object. The further analysis of the resampled image data may also include utilizing the resampled image data, e.g., to build up a database of imaged objects, to train image recognition algorithms, or the like.

In one implementation, the analyzing at step 210 includes classifying the object, i.e., assigning the object to one of a plurality of object types or classes. For example, the storage device 124 illustrated in FIG. 1 may be utilized to store the reference data that are retrieved so as to classify the object. The reference data may include information on a plurality of different object types that are selected from a group comprising cars, lorries, motorcycles, pedestrians, traffic signs or the like. For any one of these object types, the reference data are generated by capturing an image of an object having this object type, e.g., a car, while it is located at a distance from the image plane of the 2D camera 128 that is approximately equal to the pre-determined reference distance. In this manner, the reference data are tailored to recognizing images of objects that have approximately the same size as an image of a reference object located at the pre-determined reference distance from the image plane.

The reference data stored in the storage device 124 may have various forms depending on the specific implementation of the analyzing process in step 210. For example, the analyzing performed at step 210 may be based on a learning algorithm that is trained to recognize specific object types. In this case, the reference data may be a set of parameters that control operation of the learning algorithm and have been trained through the use of images of reference objects located at the reference distance from the image plane. In another implementation, the analyzing process may include determining whether the object represented by the resampled image data has specific geometrical properties, colors, color patterns, or sizes, which may be specified by the reference data. In another implementation, the analyzing process may include a bit-wise comparison of the resampled image data with a plurality of images of reference objects of various object types taken when the reference objects are located approximately at the reference distance from the image plane.

Irrespective of the specific implementation of the analyzing step 210, the reference data, may be generated based on an image of at least one of the reference objects located at a distance from the image plane that is approximately equal to the reference distance. The analyzing step 210 is then well adapted to classify the object based on the resampled image data, which has been obtained by a distance-dependent resampling.

A result of the analyzing step 210 may be output to a driver assistance system such as the driver assistance device 108 illustrated in FIG. 1. For example, information on the object type of an approaching object, such as pedestrian, car or lorry, may be output to the driver assistance device 108, which in response may actuate a safety device such as the protection device 156, and/or output a warning signal such as via the warning device 152, based on the information on the object type.

The distance information retrieved at step 204, based on which the portion of the image is resampled at step 208, may be obtained in any suitable way. In the apparatus 104 of FIG. 1, the distance information is obtained by capturing and evaluating a 3D image that includes depth information. Therefore, the apparatus 104 evaluates the image captured by the 2D camera 128 based on a sensor fusion of the 2D camera 128 and the 3D camera device 132.

As noted above, additional logical functions may be employed to identify objects in the additional image data, e.g., by evaluating the shape and/or symmetry of the pixels having comparable depth values. For example, only structures of pixels in the additional image data that have a square or trapezoidal shape may be selected for further processing if vehicles are to be identified in the image data. In this manner, evaluating the image data may be restricted to the relevant portions of the image data, thereby enhancing processing speeds.

FIG. 3 is a flow diagram illustrating a method 300 that may be performed by the apparatus 104 of FIG. 1. At step 302, a 2D image is captured, the 2D image being represented by image data. At step 304, a 3D image is captured that is represented by additional image data. At step 306, the additional image data are evaluated to identify portions of the additional image data, i.e., regions in the 3D image, that respectively represent an image to thereby generate an object list, which respectively includes distance information on distances of the objects. The object list may be generated utilizing a segmentation algorithm based on the depth information, while additional logical functions may be optionally employed that may be based on symmetries or sizes of objects. The distance information may be inferred from the depth information of the 3D image. The capturing of the 2D image at step 302 and the capturing of the 3D image at step 304 may be performed simultaneously or successively with a time delay therebetween that is sufficiently short that a motion of objects imaged in the 2D image and the 3D image remains small.

By utilizing the additional image data representing a three-dimensional image, the portion of the image data representing the object may be conveniently identified, and the distance of the object relative to the image plane may also be determined from the additional image data. In this manner, the image may be evaluated by using both the image data and the additional image data, i.e., by combining the information of a two-dimensional (2D) image and a three-dimensional (3D) image. In this context, the term “depth information” generally refers to information on distances of objects located along a plurality of viewing directions represented by pixels of the three-dimensional image.

At step 308, a portion of the image data is selected based on the additional image data. The object list generated at step 306 includes information on the pixels or pixel regions in the additional image data that represent an object. The portion of the image data is selected by identifying the pixels in the image data that correspond to the pixels or pixel regions in the additional image data specified by the object list. If the 2D image and the 3D image have identical resolution and an identical field of view, there is a one-to-one correspondence between a pixel in the image data and a pixel in the additional image data. If, however, the 3D image has a lower resolution than the 2D image, several pixels of the image data correspond to one pixel of the additional image data.

At step 310, the portion of the image data that has been selected at step 308 is resampled based on the distance information contained in the object list and the pre-determined reference distance to generate resampled image data, as has been explained with reference to step 208 of the method 200 described above (FIG. 2). At step 312, the resampled image data are analyzed to classify the object represented by the portion of the image data that is resampled.

When several objects having various distances from the image plane are identified in the additional image data, each of the portions of the image data that represents one of the objects is resampled based on the respective distance information and the pre-determined reference distance.

As will be explained with reference to FIGS. 4(a) and 4(b) next, by resampling the portion of the image data representing one of the objects, size variations of object images that are effected by distance variations may at least partially be taken into account in evaluating the image.

FIG. 4(a) is a schematic representation of an example of a 2D image. In particular, FIG. 4(a) schematically illustrates a 2D image 400 showing a road 402 and a horizon 406. Four objects 410, 414, 418 and 422, for example vehicles, are located on the road 402 at four different distances from the image plane, and sizes of the object images vary correspondingly. A learning algorithm that has been trained on reference objects located approximately at the same distance from the image plane as the object 414, which defines the reference distance, may provide good results in object classification of the object 414, but may lead to poorer results in the classification of objects 410, 418 and 422 due to the distance-induced difference in size.

FIG. 4(b) is a schematic representation of an image 450 illustrating a resampling of portions of the 2D image 400 of FIG. 4(a). As illustrated in FIG. 4(b), by downsampling the portion of the 2D image 400 that represents the object 410, resampled image data 460 are generated that are comparable in size to the portion of the 2D image 400 that represents the object 410, which is also schematically illustrated in FIG. 4(b) as 464. Similarly, by upsampling the portions of the 2D image 400 that represent the objects 418 and 422, resampled image data 468 and 472 are generated that are comparable in size to the portion of the image 400 that represents the object 414. Thus, by appropriately downsampling or upsampling a portion of the image data based on the distance of the object relative to the image plane and the reference distance, resampled image data can be generated in which one pixel corresponds to an object width that is approximately equal to that of an object represented by the original image data when the object is located at the pre-determined reference distance from the image plane. An object may therefore have an approximately equal size, measured in pixels, in the resampled image data even when the object is imaged at varying distances from the image plane, provided the distance from the image plane is not so large that the object is represented by only a few pixels of the original image data. Thereby, the objects may be virtually brought to the same object plane, as schematically shown in FIG. 4(b), where all objects 460, 464, 468 and 472 are virtually located at the reference distance from the image plane. It will be appreciated that FIG. 4(b) is only schematic, since the resampled image data do not have to be combined with the remaining portions of the image data to form a new image, but may be separately evaluated.

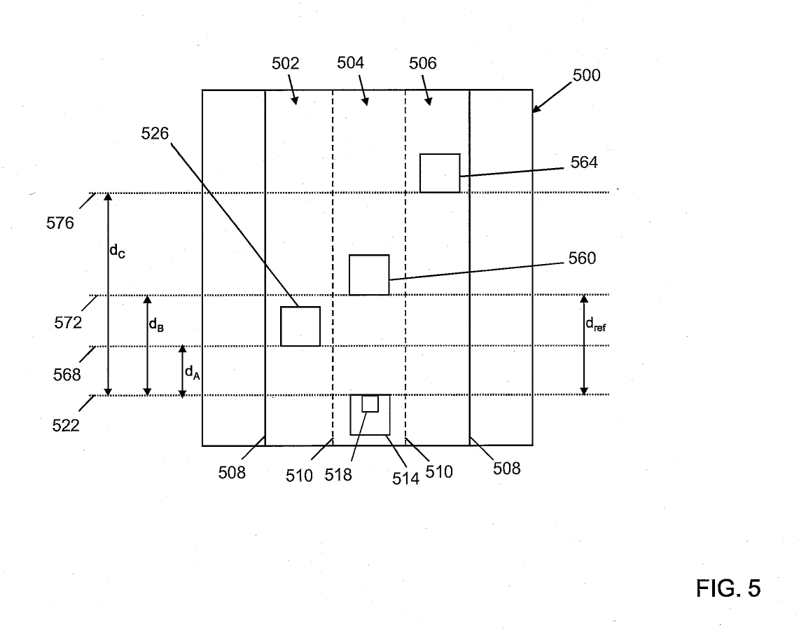

The resampling of a portion of the image data representing an object based on a 3D image will be explained in more detail with reference to FIGS. 5-8 next.

FIG. 5 is a schematic top view 500 of a road having three lanes 502, 504 and 506 that are delimited by lane markers 508 and 510. A vehicle 514 is located on the center lane 504, on which an apparatus 518 is mounted that may be configured as the apparatus 104 shown in FIG. 1. The apparatus 518 includes at least a 2D camera having an image plane 522 and a 3D camera. Three other vehicles 526, 560 and 564 are located rearward of the vehicle 514 at three different distances d_{A}, d_{B} and d_{C}, respectively, from the vehicle 514. The distances d_{A}, d_{B} and d_{C} are respectively defined as distances between the image plane 522 and object planes 568, 572 and 576 corresponding to frontmost portions of the vehicles 526, 560 and 564. The distance d_{B} between the image plane 522 and the object plane 572 associated with the vehicle 560 is equal to the reference distance d_{ref}, i.e., vehicle 560 is located at a distance from the image plane 522 that is equal to the reference distance d_{ref}.

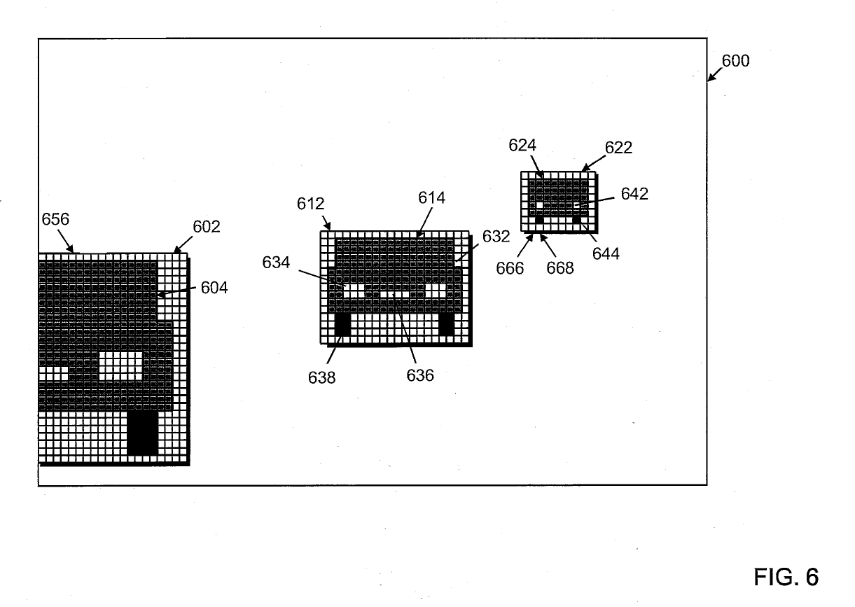

FIG. 6 is a schematic representation of image data 600 captured using the 2D camera of the apparatus 518 depicted in FIG. 5. The image data 600 has a portion 602 representing an image 604 of the vehicle 526 (FIG. 5), a portion 612 representing an image 614 of the vehicle 560, and a portion 622 representing an image 624 of the vehicle 564. Pixels of the image data 600 due to the finite pixel resolution of the 2D camera are schematically indicated. The size of the images 604, 614 and 624 representing the vehicles 526, 560 and 564, decreases with increasing distance of the vehicle 526, 560 and 564 from the image plane 522 (FIG. 5). The variation in the size of the vehicle image with distance from the image plane 522 is dependent on the specific optical characteristics of the 2D camera of the apparatus 518. For illustration, it will be assumed that the size of the vehicle image 604, 614 and 624 is approximately inversely proportional to the distances d_{A}, d_{B} and d_{C}, respectively, from the image plane 522. In the exemplary image data 600, characteristic features of the vehicle 560, such as a stepped outer shape 632, headlights 634, a number plate 636 and tires 638, can be identified in the image 614 of the vehicle 560 located at the reference distance d_{ref} from the image plane 522. All these features are also visible in the image 604 representing vehicle 526. However, due to its smaller size and the finite pixel resolution of the image data 600, not all of these features can be identified in the image 624 representing the vehicle 564. For example, the stepped outer shape and number plate are not represented by the image 624. Other features, such as the headlights 642 and tires 644, are distorted due to the finite pixel resolution.

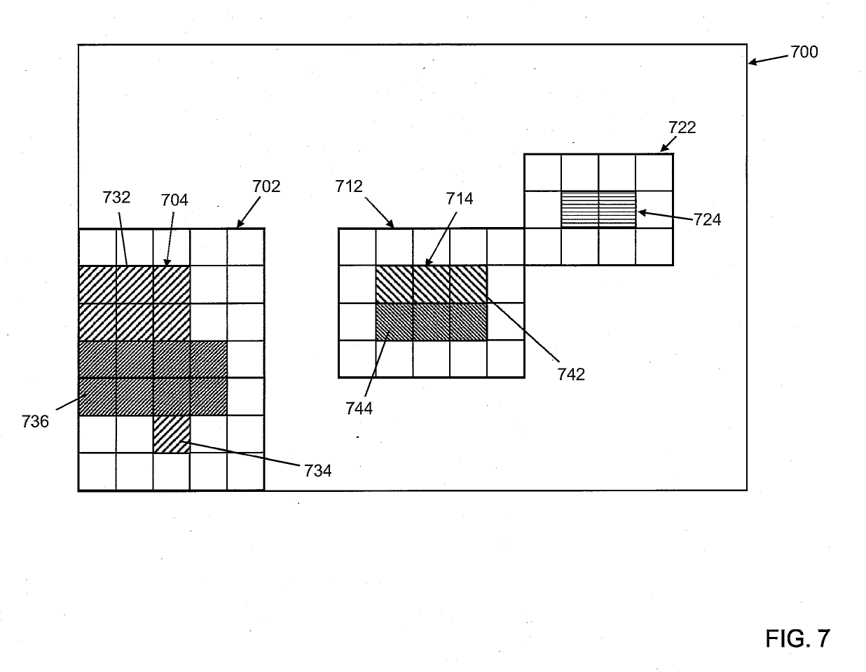

FIG. 7 is a schematic representation of additional image data 700 captured using the 3D camera of the apparatus 518 depicted in FIG. 5. The additional image data 700 has a portion 702 representing an image 704 of the vehicle 526 (FIG. 5), a portion 712 representing an image 714 of the vehicle 560, and a portion 722 representing an image 724 of the vehicle 564. Pixels of the image data due to the finite resolution of the 3D camera are schematically indicated. In the illustrated example, the pixel resolution of the 3D camera is lower than that of the 2D camera, one pixel of the 3D image corresponding to four times four pixels of the 2D image. Further, in the illustrated example, the field of view of the 2D camera is identical to that of the 3D camera. The additional image data 700 include depth information, i.e., information on distances of obstacles located along a plurality of viewing directions. Different depths are schematically indicated by different patterns in FIG. 7. For example, in the image 704 of the vehicle 526, portions 732 and 734 representing a passenger cabin and tire of the vehicle 526, respectively, have a distance relative to the 3D camera that is larger than that of the portion 736 representing a bonnet of the vehicle 526. In spite of these variations of distance values across the image 702 of the vehicle 526, a segmentation algorithm is capable of assigning the portion 702 of the additional image data 700 to one vehicle, as long as the variations of distances lay within characteristic length scales of vehicles. Similarly, while portions 742 and 744 representing a passenger cabin and bonnet, respectively, have different distances from the image plane in the image 714 of the vehicle 560, the portion 712 of the additional image data 700 may again be assigned to one vehicle. As schematically indicated by the different patterns of the image 714 as compared to the image 704, the depth information of the additional image data 700 indicates that the vehicle 560 is located further away than the vehicle 526. Similarly, the pixel values for the portion 724 indicate that the vehicle 564 represented by the image 724 is located further away than the vehicle 560.

Based on the additional image data 700, a segmentation algorithm identifies portions 702, 712 and 722 and assigns them to different objects of an object list. For each of the objects, a distance value is determined, e.g., as the lowest distance value in one of the images 704, 714 and 724, respectively, or as a weighted average of the distance values in the respective image 704, 714 or 724.

It is to be understood that, while not shown in FIG. 7 for clarity, the additional image data 700 will include depth information indicative of objects other than the vehicles 526, 560 and 564 (FIG. 5) as well, e.g., depth information indicative of the road on which the vehicles 526, 560 and 564 are located, trees on the sides of the road, or the like. Such background signal can be discriminated from signals indicative of vehicles 526, 560 and 564 based, e.g., on characteristic shapes of the latter, or based on the fact that vehicles 526, 560 and 564 frequently include vertically extending portions that produce comparable distance values throughout several adjacent pixels.

Based on the lateral positions of the portions 702, 712 and 722 in the additional image data 700 of FIG. 7, corresponding portions in the image data 600 of FIG. 6 are then resampled. The resampling includes identifying, for each of the pixels in the portions 702, 712 and 722 of the additional image data 700, corresponding pixels in the image data 600 to thereby determine the portions of the image data 600 that are to be resampled. In the illustrated example, these portions of the image data 600 correspond to portions 602, 612 and 622, respectively. For each of these portions 602, 612 and 622 of the image data 600, it is determined whether the portion 602, 612 or 622 is to be resampled. If the portion 602, 612 or 622 is to be resampled, a resampling factor is determined based on the distance of the respective object and the pre-determined reference distance d_{ref}.

In one implementation, a portion of the image data representing an object is upsampled when the object is located at a distance d from the image plane that is larger than the pre-determined reference distance d_{ref}, the upsampling factor being

sfᵤₚ=d/d_{ref} (1)

and the portion of the image data is downsampled when the object is located at a distance d from the image plane that is smaller than the pre-determined reference distance d_{ref}, the downsampling factor being

sf_{down}=d_{ref}/d. (2)

In one implementation, in order to determine an upsampling factor or downsampling factor, the fractions on the right-hand sides of Equations (1) and (2) are approximated by a rational number that does not have too large numerical values in the numerator and denominator, respectively, or the right-hand sides may be approximated by an integer.

In other implementations the upsampling and downsampling factors sfᵤₚ and sf_{down}, respectively, may be determined in other ways. For example, the focal length of the 2D camera may be taken into account to model the variations of image size with object distance, and the resampling factors may be determined by dividing the image size in pixels that would have been obtained for an object located at the reference distance from the image plane by the image size in pixels obtained for the actual object distance.

Returning to the example of FIGS. 5-7, the portion 602 of the image data 600 is downsampled by a factor sf_{down}=d_{ref}/d_{A}=2, while the portion 622 of the image data 600 is upsampled by a factor sfᵤₚ=d_{C}/d_{ref}=2. Upsampling a portion of the image data 600 by an integer upsampling factor n may be implemented by first copying every row in the portion n−1 times to generate an intermediate image, and then copying every column of the intermediate image n−1 times. Similarly, downsampling by an integer downsampling factor n may be implemented by retaining only every n^{th} row of the portion to generate an intermediate image, and then retaining only every n^{th} column of the intermediate image to generate the resampled image data. Upsampling by a fractional sampling factor sf=p/q, where p and q are integers, may be implemented by upsampling by a sampling factor p and, subsequently, downsampling by a sampling factor q. Downsampling by fractional sampling factors may be implemented in a corresponding manner.

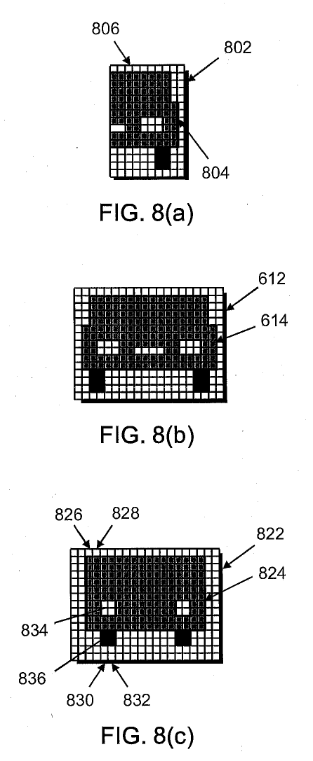

FIGS. 8(a), 8(b), and 8(c) schematically illustrate resampled image data obtained by resampling the portions 602 and 622 of the image data 600 shown in FIG. 6. FIG. 8(a) shows resampled image data 802 obtained by downsampling the portion 602 of the image data 600 by sf_{down}=2. The resulting image 804 shows the vehicle 526 (FIG. 5) at approximately the same level of detail and having approximately the same size as the image 614 of the vehicle 560 located at the reference distance d_{ref}. As explained above, the resampled image data 802 is obtained by removing every second pixel row and every second pixel column from the portion 602. For example, column 806 of the resampled image data 802 corresponds to column 656 of the portion 602 with every second pixel in the column having been removed.

FIG. 8(b) shows the image 614 of the vehicle 560 (FIG. 5). The portion 612 does not need to be resampled, since vehicle 560 is located at the reference distance d_{ref}.

FIG. 8(c) shows resampled image data 822 obtained by upsampling the portion 622 of the image data 600 (FIG. 6) by sfᵤₚ=2. In the upsampled image data, every pixel of the portion 622 has been copied onto two times two pixels. For example, column 826 of the resampled image data 822 is generated by copying every pixel of column 666 of the portion 622 onto the vertically adjacent pixel, and column 828 is a copy of column 826. Similarly, columns 830 and 832 of the resampled image data 822 are obtained from column 668 of the portion 622. While the resulting image 824 of the vehicle 564 (FIG. 5) does not include additional details as compared to the image 624 in the original image data 600, the total size of the vehicle image 824 and of specific features, such as the headlights 834 and tires 836, becomes comparable to those of the image 614 of the vehicle 560 (FIG. 5) that is located at the reference distance d_{ref} relative to the image plane 522.

As may be seen from FIGS. 8(a) and 8(c), by resampling portions of the image data 600 (FIG. 6), the images 804 and 824 of the vehicles 526 and 564 (FIG. 5) may be scaled such that the vehicles 526 and 564 are virtually brought to the reference distance d_{ref} from the image plane 522. A further analysis or evaluation of the image data that relies on reference data captured when vehicles are located at the reference distance d_{ref}, is facilitated by the resampling. For example, when a learning algorithm for image recognition has been trained on the image 614 (FIG. 6) of the vehicle 560 (FIG. 5), it may be difficult for the learning algorithm to correctly identify the images 604 and 624 in the image data 600, while images 804 and 824 in the resampled image data 802 and 822, respectively, may be more readily classified as vehicles.

Upsampling and downsampling of portions of the image data 600 may also be performed in other ways than the ones described above. For example, in downsampling, filters may be employed that model the changing resolution as a vehicle is located further away from the image plane. Thereby, the level of detail that may still be recognized in the resampled image data may be controlled more accurately. Upsampling may also be performed by using interpolating functions to interpolate, e.g., pixel color values when adding more pixels. Upsampling may also be performed by capturing a new image of the field of view in which the portion to be upsampled is located, i.e., by zooming into this field of view using the 2D camera to capture a new, higher resolution image.

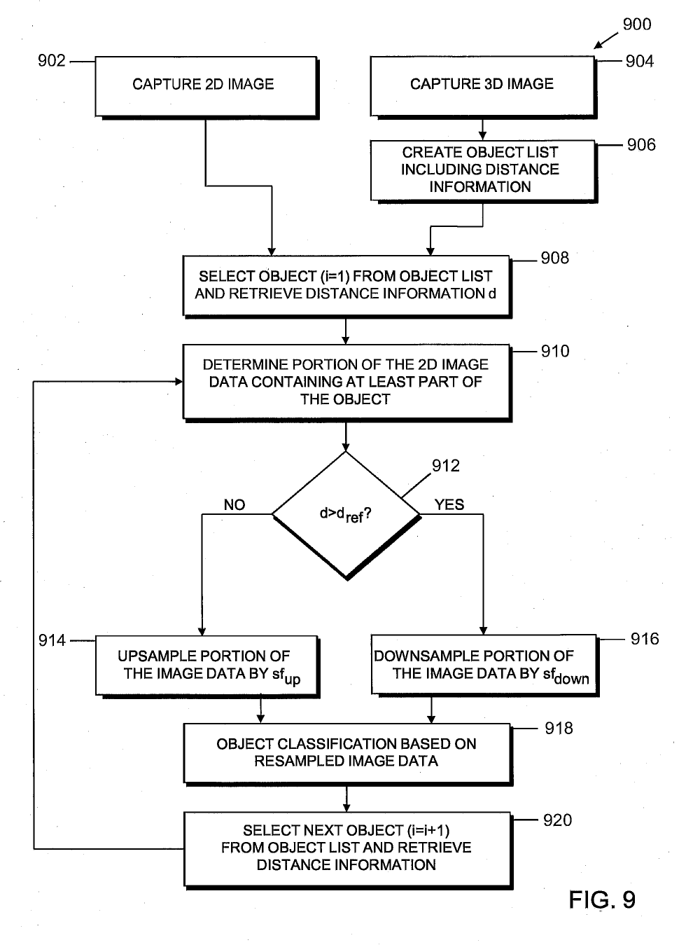

FIG. 9 is a flow diagram of a method 900 that may be performed by the apparatus 104 of FIG. 1 or the apparatus 518 of FIG. 5. In the method 900, at steps 902, 904 and 906, capturing of 2D and 3D images and generating an object list based on the 3D image are performed. These steps may be implemented as has been explained with reference to FIG. 3 above.

At step 908, an object is selected from the object list, and its distance relative to the image plane is retrieved. At step 910, a portion of the image data representing the 2D image is determined that contains at least part of the object. The determining step at step 910 may again include matching the 2D and 3D images, e.g., by mapping pixels of the 3D image onto corresponding pixels of the 2D image.

At step 912, the distance d retrieved from the object list is compared to the reference distance d_{ref}. If d is less than or equal to d_{ref}, at step 914, the portion of the image data is upsampled by an upsampling factor sfᵤₚ that may be determined, e.g., as explained with reference to Equation (1) above. If d is larger than d_{ref}, at step 916, the portion of the image data is downsampled by a downsampling factor sf_{down} that may be determined, e.g., as explained with reference to Equation (2) above.

At step 918, the object is then classified based on the resampled image data. Object classification may be performed as explained with reference to step 312 in FIG. 3.

At step 920, a new object is selected from the object list and its distance information is retrieved, and the steps at 910-918 are repeated.

The method 900 may be repeated at regular time intervals. For example, when the apparatus 104 (FIG. 1) is installed onboard a vehicle, the method 900 may be repeated several times per second to monitor the surroundings of the vehicle in a quasi-continuous manner.

It is to be understood that the configuration of the apparatus 104 for evaluating an image shown in FIG. 1 is only exemplary, and that various other configurations may be implemented in other implementations.

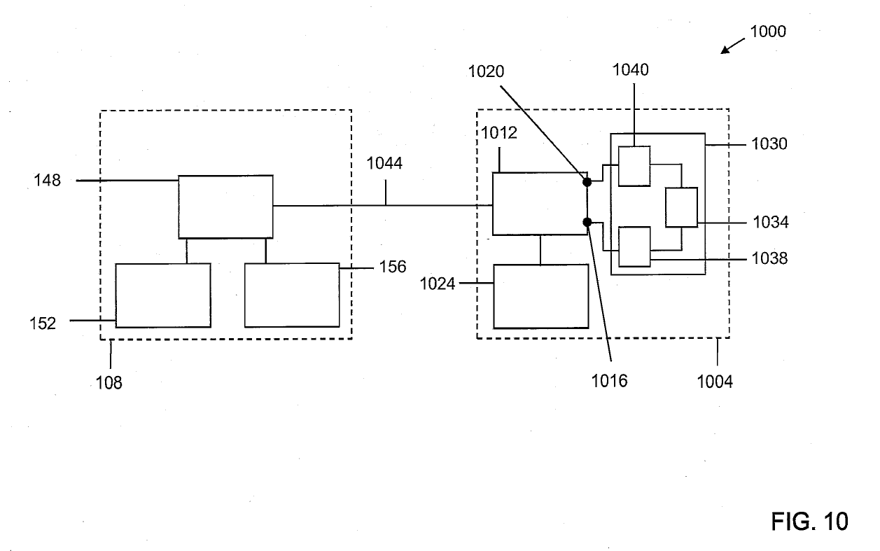

FIG. 10 is a schematic diagram of an example of a driver assistance system 1000 according to another implementation. The driver assistance system 1000 includes an apparatus 1004 for evaluating an image and an assistance device 108. The assistance device 108, which is coupled to the apparatus 1004 via a bus 1044, may be configured as described with reference to FIG. 1 above.

The apparatus 1004 includes a processing device 1012, which has a first input 1016 to receive image data representing the image to be evaluated and a second input 1020 to receive distance information on a distance of an object that is represented by the image relative to an image plane. The processing device 1012 is further coupled to a storage device 1024 that has stored thereon reference data for object classification.

The apparatus 1004 further comprises a 3D camera device 1030 that includes a 3D camera 1034, e.g., a stereo camera, an object identification device 1040 and an image processor 1038. The object identification device 1040 is coupled to the 3D camera 1034 to identify objects in a 3D image taken by the 3D camera 1034, e.g., in the two images taken by a stereo camera, and their position relative to an image plane of the 3D camera 1034, and to provide this information to the processing device 1012 at the second input 1020. The image processor 1038 is coupled to the 3D camera 1034 to generate image data representing a 2D image based on the 3D image taken by the 3D camera 1034. For example, when the 3D camera 1034 is a stereo camera, the image processor 1038 may generate a 2D image by merging data from the two images captured by the stereo camera, or the 2D image may be set to be identical to one of the two images captured by the stereo camera. The image data representing the 2D image are provided to the processing device 1012 at the first input 1016.

The processing device 1012 receives the distance information at the second input 1020 and the image data at the first input 1016, and resamples a portion of the image data based on the distance information and a pre-determined reference distance. The processing device 1012 may operate according to any one of the methods explained with reference to FIGS. 2-9 above.

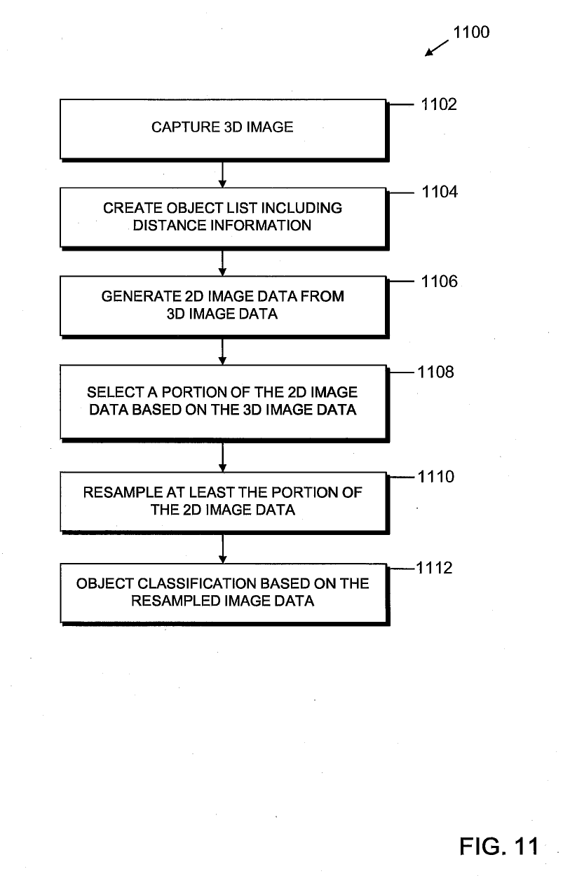

FIG. 11 is a flow diagram representation of a method 1100 that may be performed by the apparatus 1000 of FIG. 10. At step 1102, a 3D image is captured which is represented by 3D image data. At step 1104, an object list including distance information for objects represented by the image is generated based on the 3D image data. At step 1106, image data representing a 2D image are generated based on the 3D image. At step 1108, a portion of the image data is selected based on the object list, i.e., based on an analysis of the 3D image data. At step 1110, at least a portion of the image data is resampled based on the distance information and the pre-determined reference distance to thereby generate resampled image data. At step 1112, the resampled image data are evaluated, e.g., by performing object classification.

According to another aspect of the invention, a data storage medium is provided which has stored thereon instructions which, when executed by a processor of an electronic computing device, direct the computing device to perform the method according to any of the implementations described above. The electronic computing device may be configured as a universal processor that has inputs for receiving the image data and the additional image data. The electronic computing device may also comprise a processor, a CMOS or CCD camera and a PMD camera, the processor retrieving the image data from the CMOS or CCD camera and the additional image data from the PMD camera.

It is to be understood that the above description of implementations is illustrative rather than limiting, and that various modifications may be implemented in other implementations. For example, while the object identification device 140 of the apparatus 104 and the object identification device 1040 of the apparatus 1004 have been shown to be provided by the 3D camera devices 132 and 1030, respectively, the object identification device 140 or 1040 may also be formed integrally with the processing device 112 or 1012, respectively, i.e., the object list may be generated by the processing device 112 or 1012.

It is also to be understood that the various physical entities, such as the 2D camera, the 3D camera, the processing device, the object identification device, and the storage device of the apparatus, may be implemented by any suitable hardware, software or combination thereof. For example, the 2D camera may be a CMOS camera, a CCD camera, or any other camera or combination of optical components that provides image data. Similarly, the 3D camera may be configured as a PMD camera, a stereo camera, or any other device that is suitable for capturing depth information. The processing device may be a special purpose circuit or a general purpose processor that is suitably programmed.

Further, various components of the apparatus shown in FIGS. 1 and 10, or of any other implementation described above, may be formed integrally or may be grouped together to form devices as suitable for the anticipated application. For example, in one exemplary implementation, the processing device 112 and the storage device 124 of FIG. 1 may be provided by the driver assistance system 108, or the processing device 1012 and the storage device 1024 of FIG. 10 may be provided by the driver assistance system 108. Still further, the object identification device 140 may also be provided by the driver assistance device 108. The processing device 112, 1012 may be formed integrally with a control unit 148 or processor of the driver assistance device 108, i.e., one processor provided in the driver assistance device 108 may both control the operation of the warning and/or protection devices 152, 156 and may perform the method for evaluating an image according to any one implementation. Still further, the object identification device, the processing device and the control device of the driver assistance device may be integrally formed. It will be appreciated that other modifications may be implemented in other implementations, in which the various components are arranged and interconnected in any other suitable way.

While implementations of the invention have been described with reference to applications in driver assistance systems, the invention is not limited to this application and may be readily used for any application where images are to be evaluated. For example, implementations of the invention may also be employed in evaluating images captured in security-related applications such as in the surveillance of public areas, or in image analysis for biological, medical or other scientific applications.

It will be understood, and is appreciated by persons skilled in the art, that one or more processes, sub-processes, or process steps described in connection with FIGS. 1-10 may be performed by hardware and/or software. If the process is performed by software, the software may reside in software memory (not shown) in a suitable electronic processing component or system such as, one or more of the functional components or modules schematically depicted in FIGS. 1-10. The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any means that may contain, store or communicate the program for use by or in connection with the instruction execution system, apparatus, or device. The computer readable medium may selectively be, for example, but is not limited to, an electronic, magnetic, optical, electromagnetic, infrared, or semiconductor system, apparatus or device. More specific examples, but nonetheless a non-exhaustive list, of computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A method for evaluating an image, the method comprising:
retrieving image data representing the image;
retrieving distance information on a distance of an object relative to an image plane of the image, at least part of the object being represented by the image data; and
resampling at least a portion of the image data based both on the distance information and on a pre-determined reference distance to generate resampled image data, where the portion of the image data to be resampled represents at least part of the object.

2. The method of claim 1, where the portion of the image data is resampled by a resampling factor determined based on a comparison of the distance of the object and the reference distance.

3. The method of claim 1, where resampling includes upsampling when the distance of the object exceeds a first pre-determined threshold, the first pre-determined threshold being larger than or equal to the reference distance, and resampling includes downsampling when the distance of the object is less than a second pre-determined threshold, the second pre-determined threshold being less than or equal to the reference distance.

4. The method of claim 1, where the portion of the image data is resampled such that a pixel of the resampled image data corresponds to an object width that is approximately equal to a width per pixel in the image data of an object located at the reference distance from the image plane.

5. The method of claim 1, further including obtaining additional image data representing a three-dimensional image and comprising depth information, where a field of view of the three-dimensional image overlaps with a field of view of the image to be evaluated.

6. The method of claim 5, further including identifying a portion of the additional image data representing at least part of the object based on the depth information.

7. The method of claim 6, further including selecting the portion of the image data to be resampled based on the identified portion of the additional image data.

8. The method of claim 7, where selecting the portion of the image data includes identifying at least one pixel of the image data that corresponds to a pixel of the additional image data included with the identified portion of the additional image data.

9. The method of claim 5, further including determining the distance information based on the additional image data.

10. The method of claim 5, further including capturing the image to be evaluated utilizing a two-dimensional camera and capturing the three-dimensional image utilizing a three-dimensional camera.

11. The method of claim 1, where the steps of retrieving distance information and resampling are respectively performed for each of a plurality of objects represented by the image data.

12. The method of claim 1, further including analyzing the resampled image data to classify the object into one of a plurality of object types, and providing a result of the analyzing to a driver assistance device.

13. The method of claim 1, further including:
retrieving reference data on a plurality of reference objects representing a plurality of object types; and
analyzing the resampled image data based on the reference data to classify the object into one of the plurality of object types.

14. The method of claim 13, where the reference data are generated based on an image of at least one of the reference objects at a distance from the image plane that is approximately equal to the reference distance.

15. The method of claim 13, where the steps of retrieving distance information, resampling and analyzing are respectively performed for each of a plurality of objects represented by the image data.

16. The method of claim 13, further including providing a result of the analyzing to a driver assistance device.

17. An apparatus for evaluating an image, the apparatus comprising:
a processing device including a first input for receiving image data representing the image and a second input for receiving distance information on a distance of an object relative to an image plane of the image, at least part of the object being represented by the image;
where the processing device is configured for resampling at least a portion of the image data based both on the distance information and on a predetermined reference distance to generate resampled image data, the portion of the image data to be resampled representing at least part of the object.

18. The apparatus of claim 17, further including a three-dimensional (3D) camera device coupled, to the second input, the 3D camera device being configured to capture additional image data representing a three-dimensional image and including depth information, where a field of view of the three-dimensional image overlaps with a field of view of the image to be evaluated.

19. The apparatus of claim 18, where the 3D camera device includes an object identification device configured for identifying objects and their respective distances based on the further image data.

20. The apparatus of claim 19, where the object identification device is configured for determining the distance information based on the additional image data and for providing the distance information to the processing device.

21. The apparatus of claim 18, where the 3D camera device is configured for providing information on a portion of the additional image data representing at least part of the object to the processing device.

22. The apparatus of claim 21, where the processing device is configured for selecting the portion of the image data based on the information on the portion of the additional image data.

23. The apparatus of claim 17, further including a two-dimensional (2D) camera coupled to the first input of the processing device and configured for capturing the image to be evaluated.

24. The apparatus of claim 17, where the processing device is configured for resampling the portion of the image data by a resampling factor determined based on a comparison of the distance of the object and the reference distance.

25. The apparatus of claim 17, where the processing device is configured for resampling the portion of the image data when the distance of the object exceeds a first pre-determined threshold, the first pre-determined threshold being larger than or equal to the reference distance, and for downsampling the portion of the image data when the distance of the object is less than a second pre-determined threshold, the second predetermined threshold being less than or equal to the reference distance.

26. The apparatus of claim 17, where the processing device is configured for resampling the portion of the image data such that a pixel of the resampled image data corresponds to an object width that is approximately equal to a width per pixel in the image data of an object located at the reference distance from the image plane.

27. The apparatus of claim 17, further including a storage device having stored thereon reference data on a plurality of reference objects representing a plurality of object types, the processing device being coupled to the storage device to retrieve the reference data and being configured for analyzing the resampled image data based on the reference data to classify the object into one of the plurality of object types.

28. The apparatus of claim 27, where the reference data are generated based on an image of at least one of the reference objects at a distance from the image plane that is approximately equal to the reference distance.

29. A driver assistance system, comprising:
an image evaluating apparatus including:
a processing device including a first input for receiving image data representing the image and a second input for receiving distance information on a distance of an object relative to an image plane of the image, at least part of the object being represented by the image;
where the processing device is configured for resampling at least a portion of the image data based both on the distance information and on a pre-determined reference distance to generate resampled image data, the portion of the image data to be resampled representing at least part of the object; and
an assistance device configured for receiving an image evaluation result from the image evaluating apparatus.

30. The driver assistance system of claim 29, where the assistance device includes an output unit for providing at least one of optical, acoustical or tactile output signals based on the image evaluation result received from the image evaluating apparatus.

31. The driver assistance system of claim 29, where the assistance device includes an occupant and/or pedestrian protection system coupled to the apparatus and configured to be actuated based on the image evaluation result received from the image evaluating apparatus.

32. A method for evaluating an image, the method comprising:
capturing an image;
capturing a three-dimensional image including depth information, a field of view of the three-dimensional image overlapping with a field of view of the image; and
resampling at least a portion of the image based on the three-dimensional image.

33. An apparatus for evaluating an image, the apparatus comprising:
a camera device configured for capturing an image;
a three-dimensional (3D) camera device configured for capturing a three-dimensional image including depth information, a field of view of the three-dimensional image overlapping with a field of view of the image; and
a processing device coupled to the camera device for receiving image data representing the image from the camera device and coupled to the 3D camera device for receiving additional image data representing the three-dimensional image from the 3D camera device, the processing device being configured for resampling at least a portion of the image data based on the additional image data.
